(19) United States
(12) Patent Application Publication
(10) Pub. No.: US 2023/0020205 A1
(43) Pub. Date: Jan. 19, 2023

(54) In-Kitchen Label System

(71) Applicant: Rayford Hull, Friendswood, TX (US)

(72) Inventor: Rayford Hull, Friendswood, TX (US)

(21) Appl. No.: 17/379,198

(22) Filed: Jul. 19, 2021

(51) Int. Cl. B41J 3/407; B41J 29/393; G06K 15/02; G06K 15/00

(52) U.S. Cl. CPC B41J 3/4075; B41J 29/393; G06K 15/024; G06K 15/028; G06K 15/005

(57) ABSTRACT

A thermal label printer system may include a book-shaped housing comprising a front cover and a rear cover with the front cover attached to a rear cover along an interface and configured to rotate about the interface with respect to the rear cover between an open position and a closed position. The thermal label printer system may also include a thermal printer having a printer casing secured within the book-shaped housing, as well as an input device, a thermal print head, and a controller. The controller configured to determine an output based at least in part on an input signal received from the input device. The output is configured to cause the thermal print head to print a label having at least a name of a food item and a determined expiration date for the food item.

### BACKGROUND

Label systems (e.g., label makers and label printers) are used to print various types of information (e.g., barcodes, price tags, etc.) on self-adhesive label material. Generally, label systems include a casing that supports and/or holds a print head and other components. However, the print head and the other components (e.g., keyboard, display, power plug, etc.) may be positioned at least partially external to the casing. As such, these components may be exposed to liquids and/or other substances present during use in a kitchen environment. These liquids and/or other substances may potentially contaminate, clog, and/or damage the electronics and mechanical components of the label systems.

### BRIEF DESCRIPTION OF THE DRAWINGS

These drawings illustrate certain aspects of some of the embodiments of the present disclosure and should not be used to limit or define the method.

FIG. 1A illustrates a perspective view of a housing of a thermal label printer system, in accordance with some embodiments of the present disclosure.

FIG. 1B illustrates a top view of the thermal label printer system with the housing in an open position, with some embodiments of the present disclosure.

FIG. 2 illustrates a block diagram of the thermal label printer system, in accordance with some embodiments of the present disclosure.

FIG. 3 illustrates a top views of a thermal printer with a top cover removed, in accordance with some embodiments of the present disclosure.

FIG. 4 illustrates a top view of a card storage unit disposed in the housing, in accordance with some embodiments of the present disclosure.

FIG. 5 illustrates a top view of a printed thermal label, in accordance with some embodiments of the present disclosure.

FIG. 6 illustrates a flow chart of a method for generating and printing a thermal label for a food item, in accordance with one or more embodiments.

### DETAILED DESCRIPTION

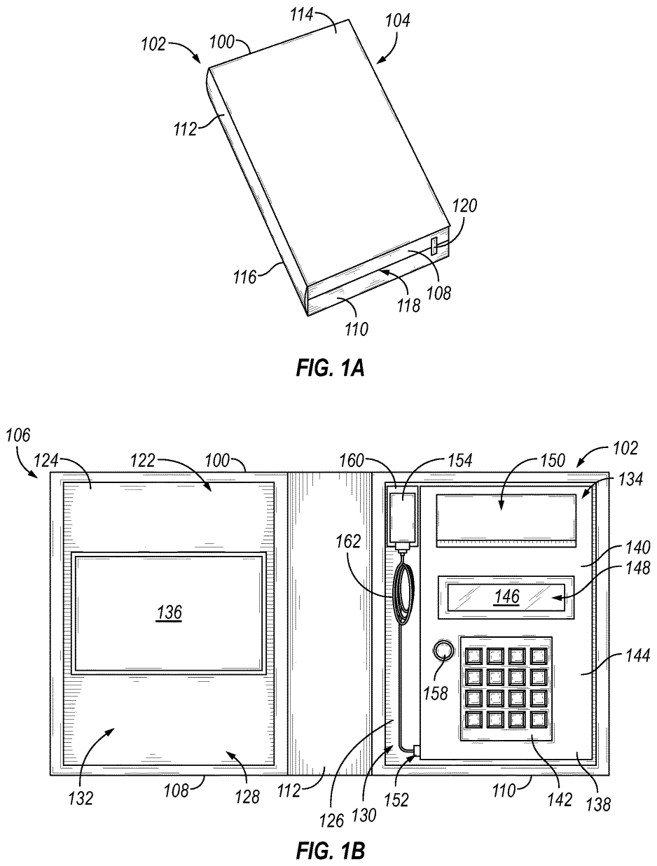

FIGS. 1A and 1B illustrate the housing 100 of the thermal label printer system 102 in a closed position 104 and an open position 106, respectively. In particular, FIG. 1A illustrates a perspective view of the housing 100 of the thermal label printer system 102 in the closed position 104, in accordance with some embodiments of the present disclosure. In the illustrated embodiment, the housing 100 is a book-shaped housing 100 comprising a front cover 108 and a rear cover 110. The front cover 108 may be attached to the rear cover 110 along an interface 112 (e.g., spine) and configured to rotate about the interface 112 with respect to the rear cover 110 between the open position 106 and the closed position 104. The book-shaped housing 100 may be configured to resemble a book (e.g., a cookbook) such that the thermal label printer system 102 may be stored on display (e.g., on the counter, on a shelf, etc.) in a kitchen without detracting from the aesthetics of the kitchen.

The book-shaped housing 100 may be stored in the closed position 104 to protect components of the thermal label printer system 102 stored within the book-shaped housing 100. The book-shaped housing 100 may include a hard plastic material 114 such as a polycarbonate, polypropylene, or another suitable hard plastic material 114. The hard plastic material 114 may be configured to resist cracking in the event of a fall. In some embodiments, the housing 100 may further include a shock absorbing material 116 (e.g., silicone, neoprene, natural rubber, etc.) secured to external corners, edges, surfaces, or some combination thereof, of the housing 100. The shock absorbing material 116 may be configured to reduce impact shock on internal components of the thermal label printer system 102, and/or the hard plastic material 114, in the event of a fall. Indeed, the housing 100 may include the hard plastic material 114, the shock absorbing material 116, or some combination thereof.

Additionally, the book-shaped housing 100 may include a substantially waterproof material such that the book-shaped housing 100 may prevent common kitchen liquids (e.g., water, oil, milk, etc.) from leaking into the book-shaped housing 100. The hard plastic material 114 and/or the shock absorbing material 116 may be substantially waterproof materials. However, in some embodiments, an additional layer of waterproofing material may be applied to the housing 100. Further, the front cover 108 and the rear cover 110 may contact each other at a sealing interface 118 in the closed position 104. The front cover 108 and the rear cover 110 may be shaped to form a press fit seal at the sealing interface 118 in the closed position 104. However, the front cover 108 and the rear cover 110 may be sealed to each other at the sealing interface 118 in any suitable manner. Sealing the front cover 108 and the rear cover 110 to each other at the sealing interface 118 may also prevent liquids from leaking into the book-shaped housing 100 in the closed position 104.

In some embodiments, the thermal label printer system 102 includes a securing device 120 to hold the book-shaped housing 100 in the closed position 104. The securing device 120 may include a belt, a latch, magnets, snap buttons, or any suitable securing device 120. For example, the securing device 120 may include a male snap button secured to the front cover 108 and a corresponding female snap button secured to the rear cover 110. Closing the book-shaped housing 100 may engage the male snap button with the female snap button such that the male snap button snaps into the female snap button, thereby, securing the front cover 108 to the rear cover 110.

Moreover, FIG. 1B illustrates a top view of the housing 100 of the thermal label printer system 102 in the open position 106, in accordance with some embodiments of the present disclosure. In the open position 106, an interior 122 of the book-shaped housing 100 is accessible. The interior 122 of the book-shaped housing 100 includes a first interior surface 124 of the front cover 108 and a second interior surface 126 of the rear cover 110. A first recess 128 may be formed in the first interior surface 124 of the front cover 108, and a second recess 130 may be formed in the second interior surface 126 of the rear cover 110. In the closed position 104, the first recess 128 and the second recess 130 may define a cavity 132 for storing the components of the thermal label printer system 102. For example, in the illustrated embodiment, the interior 122 of the book-shaped housing 100 may be configured to store a thermal printer 134, as well as a code storage unit 136.

The thermal printer 134 is configured to print labels (shown in FIG. 5) that indicate expiration dates or “best by” dates, as well as other information for food items. Having the thermal printer 134 stored in the housing 100 of the thermal printer 134 system, which may be stored on a counter or shelf of a kitchen, may provide convenient access to the thermal printer 134 as the various food items that may require labels may also be stored in the kitchen. The thermal printer 134 may include a printer casing 138 secured to the first interior surface 124 and/or second interior surface 126 of the book-shaped housing 100. In the illustrated embodiment, the printer casing 138 is secured to the second interior surface 126 of the rear cover 110. The printer casing 138 may include a second hard plastic material 140, which may be the same material as or a different material from the hard plastic material 114 used for the housing 100. The printer casing 138 may alternatively or additionally include any suitable material for holding and/or supporting other components of the thermal printer 134.

As illustrated, the thermal printer 134 may include an input device 142 secured to an external portion 144 of the printer casing 138. The input device 142 may include a matrix membrane keypad, a dome-switch keypad, a scissor-switch keypad, a capacitive keypad, or any suitable input device 142. Further, the thermal printer 134 may include a display unit 146 secured to the external portion 144 of the printer casing 138. The display unit 146 may be configured to display a user interface 148 for the thermal printer 134. The display unit 146 may include a liquid crystal display (LCD), light-emitting diode (LED) display, or another suitable display. In some embodiments, the thermal printer 134 may include a touchscreen configured to operate as both the input device 142 and the display unit 146.

The thermal printer 134 may also include a thermal print head 150 configured to print labels on thermally sensitive material (e.g., thermal paper) by energizing resistors mounted on a substrate to generate heat. The thermal paper may be selectively passed over the generated heat by the thermal print head 150 to produce images or characters on the thermal paper, thereby, printing the label. Generally, the thermal print head 150 may be configured to print labels based on input received via the input device 142.

The thermal printer 134 may also include a power supply system 152. In the illustrated embodiment, the power supply system 152 has a power supply plug 154 configured to connect with an electrical outlet (not shown) to provide power to the thermal label printer system 102. In some embodiments, the power supply system 152 includes a battery 156 (e.g., internal Li-Ion battery) to provide power to operate the thermal label printer system 102. The power supply plug 154 may be configured to connect to an external power source (e.g., the electrical outlet) to recharge the battery 156. However, in another embodiment, the power supply plug may provide power to operate the thermal label printer system 102 without the battery 156. The power supply system 152 may further include a power button 158 secured to the printer casing 138.

Moreover, the thermal label printer system 102 may further include a power cable storage block 160 having a storage outlet configured to receive the power supply plug 154. When not in use, the power supply plug 154 and corresponding power cable 162 may be stored within the housing 100 of the thermal label printer system 102. The power supply plug 154 may be inserted into the power cable storage block 160 to hold the power supply plug 154 and corresponding power cable 162 in place within the housing 100 for storage. As illustrated, the power cable storage block 160 may be secured to the second interior surface 126 of the rear cover 110 in a position proximate the thermal printer 134.

As set forth above, the thermal label printer system 102 may further include the code storage unit 136 secured to the first interior surface 124 and/or second interior surface 126 of the book-shaped housing 100. In the illustrated embodiment, the code storage unit 136 is secured to the first interior surface 124 of the front cover 108. The code storage unit 136 may include a digital and/or printed record of food codes corresponding to various food items, as well as other information corresponding to the food items. The food codes may be used by the thermal printer 134 to identify the food items during operation of the thermal label printer system 102.

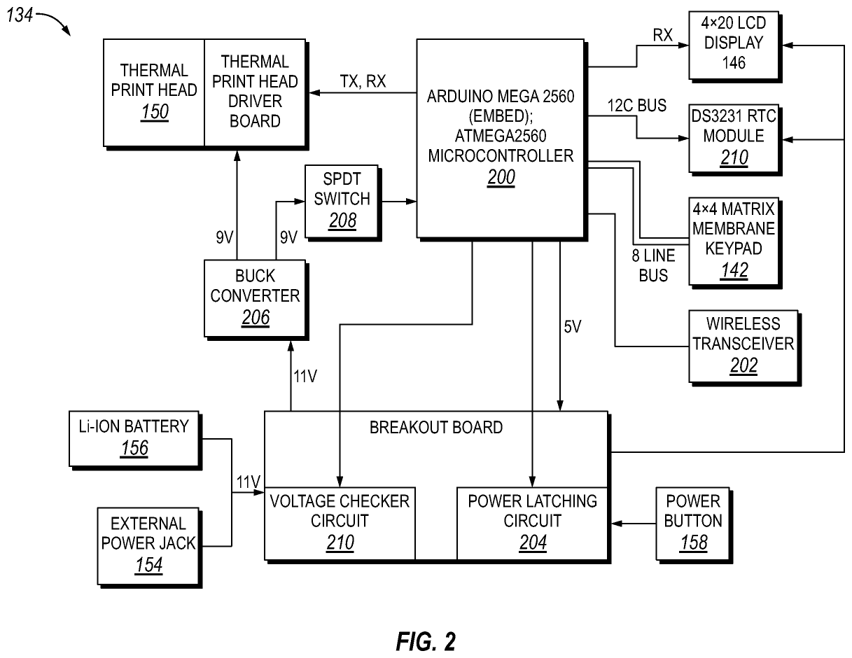

FIG. 2 illustrates a block diagram of the thermal printer 134, in accordance with some embodiments of the present disclosure. The thermal printer 134 includes a controller 200 (e.g., an Arduino microcontroller) configured to determine an output based at least in part on an input signal received from the input device 142 (e.g., keypad, touchscreen, etc.). In some embodiments, the thermal printer 134 includes a wireless transceiver 202 configured to receive information from an external device (e.g., cellular phone) and instead transmit the input signal to the controller 200 based on the information received from the external device. For example, the wireless transceiver 202 may include a Bluetooth transceiver configured to pair with a cellular phone or other suitable device. The cellular phone may transmit information (e.g., a food code) based on user selection within an application corresponding to the thermal label printer system 102, and the wireless transceiver 202 may be configured to receive the information and send the input signal to the controller 200 based on the information received from the cellular phone. Moreover, the controller 200 may send output signals to the display unit 146 and/or the thermal print head 150. For example, a display output signal may be configured to cause the display unit 146 to display various options of the user interface 148, and a print output signal may be configured to cause the thermal print head 150 to print a label.

As set forth above, the thermal printer 134 includes the power button 158. Actuating the power button 158 may cause a power latching circuit 204 to allow power to flow to a buck converter 206 from the battery 156 and/or external power source via the power supply plug 154. The buck converter 206 may provide power to the thermal print head 150 and the controller 200. In some embodiments, the thermal printer 134 may include a switch 208 (e.g., single pole double throw switch) having an on position and an off position. In the off position, the switch 208 may prevent power from flowing from the buck converter 206 to the controller 200. The switch 208 may be moved to the off position to program the controller 200 of the thermal printer 134. During programming, a USB may be connected to the controller 200 from an external device, and power may flow to the controller 200 via the USB. As powering the controller 200 from multiple sources (e.g., the buck converter 206 and the USB) can damage the controller 200, the switch 208 may prevent damage to the controller 200 during programming. Moreover, the controller 200 may provide power to the display unit 146, as well as a real-time clock (RTC) 210 connected to the controller 200.

Further, in response to actuating the power button 158 and providing power to the controller 200, the controller 200 may automatically run diagnostic checks to ensure the RTC 210 still has charge and to check the charge of the battery 156 of the thermal printer 134. In particular, the controller 200 may communicate with a voltage checker circuit 212 to check the charge of the battery 156. The controller 200 may also read the date that is being kept by the RTC 210 and update the date kept by the RTC 210, if necessary. Also, after 30 seconds of non-use (e.g., no input signals received), the controller 200 may be configured to send an auto shut-down signal to the power latching circuit 204 to power down all parts of the thermal label printer system 102.

During operation, the display unit 146 may be configured to show the user interface 148. The user interface 148 may include any suitable interface for obtaining user submitted information for the thermal label. In one embodiment, the user interface 148 may output a first query to the display unit 146. For example, the first query may ask the user to input a food item code (e.g., “102”) corresponding to a food item (e.g., beef brisket). In response to receiving input of the food item code, the controller 200 may cause the user interface 148 to output a second query asking the user to input if the food item is cooked or uncooked. The user interface 148 may be configured to output any number of queries. For example, the user interface 148 may further output queries regarding a storage location of the food item (e.g., a freezer, a refrigerator, a pantry), a bought date, a cook date, comments, or any other suitable query. Based on input received, the controller 200 may be configured to determine an expiration date or “best by” date of the food item. In some embodiments, the controller is programmed with a number of days until expiration or “best-by” (e.g., 3 days, 5 days, 2 months, etc.) corresponding to each unique combination of queries set forth above. The controller may determine the expiration date by adding the number of days until expiration or “best-by” to the stored dated (e.g., current date kept by the RTC 210). Based on the determined expiration date or “best by” date and the input received, the controller 200 may send the print output signal to cause the thermal print head 150 to print a label having at least a name of the food item and a determined expiration date for the food item. However, in some embodiments, the label may include additional information (e.g., date stored, storage location of the food item, etc.) corresponding to the received input as well as the real-time clock 210 of the thermal printer 134.

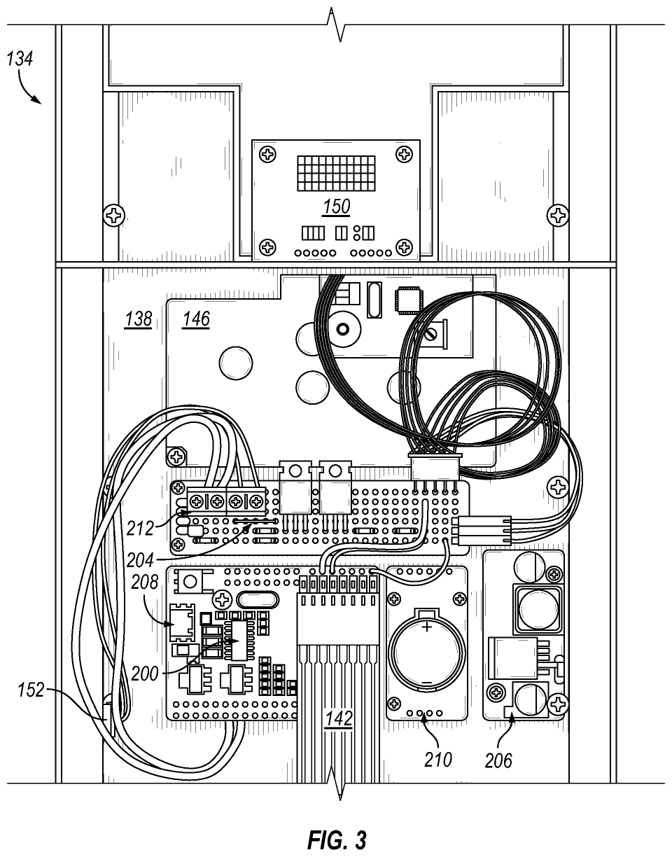

FIG. 3 illustrates a top views of a thermal printer 134 with a top cover removed, in accordance with some embodiments of the present disclosure. In the illustrated embodiment, the thermal printer 134 includes the controller 200, the real-time clock 210, the buck converter 206, the display unit 146 with serial communication and a piezo speaker, input device 142, the thermal print head 150, the voltage checker circuit 212, the power latching circuit 204, a power jack of the power supply system 152, and the switch 208, which may be disposed within the printer casing 138 as shown. However, the components may be secured in any suitable arrangement.

The piezo speaker may be configured to emit sound tones in response to receiving instructions from the controller 200. For example, as the user inputs the food item code, the controller may determine whether the food item code is valid (e.g., programmed into the thermal label printer system 102) and send instructions to the piezo speaker with respect to the validity of the food item code. The piezo speaker may be configured to emit a first tone (e.g., a pleasant tone) in response to instructions corresponding to the user inputting a valid food item code. Further, the piezo speaker may be configured to emit a second tone (e.g., unpleasant tone) in response instructions corresponding to the user inputting an invalid food item code. Accordingly, the piezo speaker may output sound tones to guide the users interacting with the user interface.

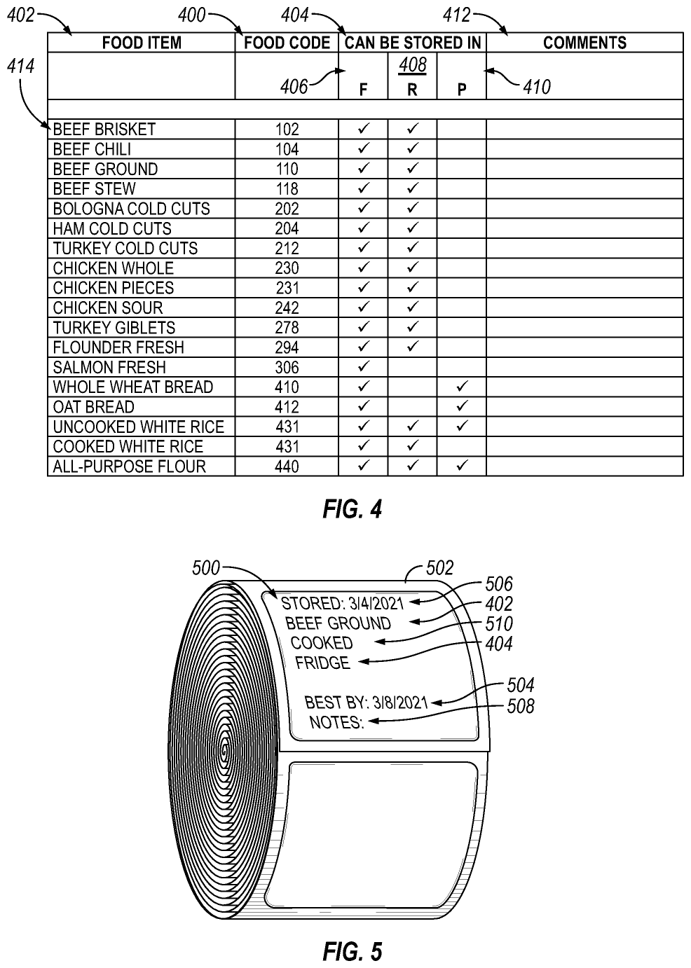

FIG. 4 illustrates a top view of the card storage unit 136 disposed in the housing 100, in accordance with one or more embodiments. As set forth above, the code storage unit 136 may be secured to the first interior surface 124 and/or second interior surface 126 of the book-shaped housing 100 (shown in FIG. 1B). Generally, the code storage unit 136 is secured to the interior 122 surface opposite the thermal printer 134. For example, the code storage unit 136 is generally secured to the first interior surface 124 when the thermal printer 134 is secured to the second interior surface 126.

The code storage unit 136 is configured to store food codes 400 corresponding to various food items 402, as well as other information related to the food item. In the illustrated embodiment, the code storage unit 136 includes a list of the food items 402 with corresponding information such as the food code 400, storage location 404 [e.g., a freezer (F) 406, refrigerator (R) 408, or a pantry (P) 410], and other comments 412. For example, the food item 402 beef brisket 414 indicates that its food code 400 is “102” and that the beef brisket 414 may be stored in the refrigerator 408 or the freezer 406. The information provided in the code storage unit 136 (e.g., the food code 400, storage location 404, etc.) may be referenced for various queries from the thermal printer 134 (shown in FIG. 1B). In some embodiments, the code storage unit 136 may include additional food items 402, as well as other information.

In some embodiments, the code storage unit 136 is an electronic device configured to digitally store the food codes 400 and other information for use with the thermal printer 134. Additionally, the code storage unit 136 may be in electrical communication with the controller 200. However, in other embodiments, the code storage unit 136 may include a non-digital record of the food codes 400 and other information. For example, the code storage unit 136 may include printed document(s) secured to the first interior surface 124 of the housing 100 (shown in FIG. 1B).

FIG. 5 illustrates a front view of a printed thermal label 500, in accordance with some embodiments of the present disclosure. The label 500 may include thermal paper 502 having an adhesive backing. The adhesive backing may be for adhering the label 500 to various food items (e.g., packing of the food items). As set forth above, the controller 200 (shown in FIG. 2) may send the print output signal to cause the thermal print head 150 to print the label 500 with the determined expiration or “best by” date 504 and additional information (e.g., date stored 506, storage location 404, etc.). In some embodiments, the label 500 includes at least the name of the food item 402 and the determined expiration or “best by” date 504 for the food item 402. The label 500 may also include printing date of the label, a shelf-life duration, storage notes 508, or some combination thereof. For example, in the illustrated embodiment, the thermal label includes the date stored 506 (e.g., the printing date of the label), the food item 402, an indication 510 that the food item 402 is cooked, the storage location 404 of the food item 402, and the “best by” date 504 for the food item 402. However, any suitable information may be printed on the label 500.

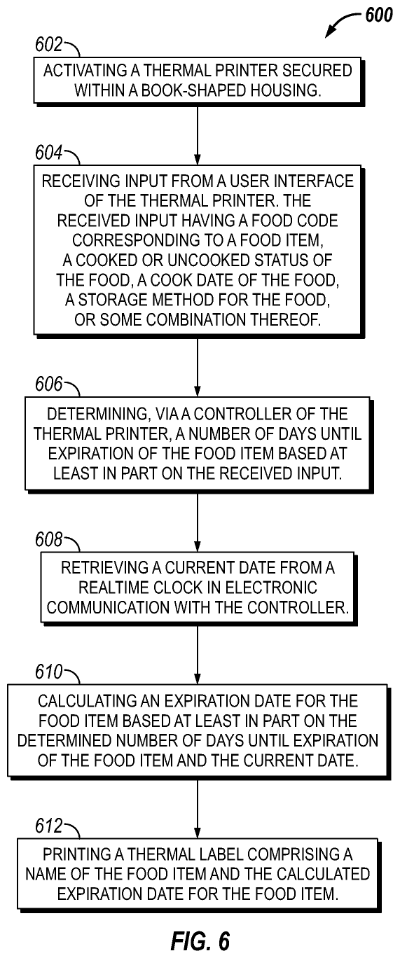

FIG. 6 illustrates a flow chart of a method for generating and printing a thermal label for a food item, in accordance with one or more embodiments. The method includes the step of activating the thermal printer secured within a book-shaped housing. As set forth above, the book-shaped housing includes the front cover and the rear cover with the front cover attached to the rear cover along the interface (e.g., the spine). The book-shaped housing may move between the open position and the closed position by rotating the front cover about the interface with respect to the rear cover. Further, as set forth above, the first interior surface of the front cover and the second interior surface of the rear cover define a cavity in the closed position. Moreover, activating the thermal printer may include providing power to components of the thermal printer (e.g., the controller, the thermal print head, etc.) in response to actuation of the power button.

The method further includes the step of receiving input from a user interface of the thermal printer. Upon activation, the controller may output a first query to the user interface shown on the display unit. As set forth in the example above, the first query may ask the user to input a food item code (e.g., “102”) corresponding to a food item (e.g., beef brisket) via the input device. In response to receiving input of the food item code, the controller may output a second query to the user interface asking the user to input if the food item is cooked or uncooked. The user interface may be configured to output any number of queries. For example, the user interface may further output queries regarding a storage location of the food item (e.g., a freezer, a refrigerator, a pantry), humidity level of storage location, storage temperature, a bought date, a cook date, comments, or any other suitable query.

Additionally, the method includes the step of determining, via a controller of the thermal printer, a number of days until expiration of the food item based at least in part on the received input. The controller may be pre-programmed with a number of days until expiration or number of days until a “best-by” state of the food item (e.g., 3 days, 5 days, 2 months, etc.) corresponding to each unique combination of received inputs to the queries. In some embodiments, the controller may not include a food code for a particular food item. However, additional food items may be programmed into the controller via the user interface. For example, the user interface may include a custom food option. The custom food option may initiate a series of queries configured to determine the number of days until expiration of the additional food item not stored in the controller. Based on the received input, the controller may generate a new food code for the additional food item as well as a number of days until expiration for various combinations of responses to queries regarding the additional food item. After finishing the series of queries associated with the custom food option, the new food code may be active for use by the thermal printer.

Moreover, the method also includes the step of retrieving a current date from a real-time clock (RTC) in electronic communication with the controller. As set forth above, the thermal printer may include the RTC connected to the controller via a wired connection. The controller may be configured to output a date request to the RTC, and the RTC may be configured to output the current date, current time, etc. to the controller in response to the date request. Further, the method includes the step of calculating an expiration date for the food item based at least in part on the determined number of days until expiration of the food item and the current date. In some embodiments, the controller may determine the expiration date by adding the number of days until expiration or the number of days until a “best-by” state of the food item to the stored date (e.g., current date received from the RTC).

Further, the method includes the step of printing a thermal label comprising a name of the food item and the calculated expiration date for the food item. In some embodiments, the thermal label may be printed with additional information (e.g., the stored date, the storage location, the cooked status of the food item, etc.) The controller may be configured to output instructions to the thermal printer to print a label with the calculated expiration date for the food item, as well as additional information.

What is claimed is:

1. A thermal label printer system, comprising:
a book-shaped housing comprising a front cover and a rear cover, the front cover attached to a rear cover along an interface and configured to rotate about the interface with respect to the rear cover between an open position and a closed position, wherein the front cover and the rear cover each comprise a waterproof material, wherein the front cover and the rear cover are sealed to each other at a sealing interface in the closed position to prevent liquids from entering into the book-shaped housing, wherein the front cover comprises a first magnet and the rear cover comprises a corresponding second magnet configured to secure the front cover to the rear cover in the closed position, and wherein a first interior surface of the front cover and a second interior surface of the rear cover define a cavity in the closed position;
a thermal printer comprising:
a printer casing secured to the first interior surface and/or second interior surface of the book-shaped housing;
an input device;
a thermal print head; and
a controller configured to determine an output based on inputs received via the input device, wherein the output is configured to cause the thermal print head to print a label, wherein the label comprises at least a name of a food item and a determined expiration date for the food item, and wherein the controller is configured to calculate the determined expiration date based on a first input corresponding to an in-kitchen storage location for the food item, a second input corresponding to a cooked or uncooked status of the food item, a third input corresponding to a cook date of the food item, and the current date, and wherein the input corresponding to the in-kitchen storage location for the food item is selected from a group of options comprising a freezer, a refrigerator, and a pantry.

2. (canceled)

3. The thermal label printer system of claim 1, wherein the label further comprises a printing date of the label, a shelf-life duration, storage notes, or some combination thereof.

4. The thermal label printer system of claim 1, wherein the thermal printer comprises a display unit configured to display a user interface for the thermal printer.

5. The thermal label printer system of claim 1, further comprising a code storage unit secured to the first interior surface and/or second interior surface of the book-shaped housing, the code storage unit comprising codes corresponding to various foods, and wherein the input device is configured to enter the codes.

6. The thermal label printer system of claim 5, wherein the code storage unit is configured to digitally store the codes for the thermal printer, and wherein the code storage unit is in electrical communication with the controller.

7. The thermal label printer system of claim 5, wherein the code storage unit comprises a non-digital record of the codes for the thermal printer.

8. The thermal label printer system of claim 1, further comprising a power supply system having a power supply plug configured to interface with an electrical outlet to provide power to the thermal label printer system, and wherein power supply plug is stored within the cavity in the closed position of the book-shaped housing.

9. The thermal label printer system of claim 1, further comprising a power cable storage block having a storage outlet configured to receive a power supply plug, the storage outlet configured to hold the power supply plug and corresponding cable in place for storage, and wherein the power cable storage block is secured to the second interior surface of the rear cover such that the power cable storage block is disposed within the cavity in the closed position.

10. The thermal label printer system of claim 1, further comprising a battery device configured to provide power to the thermal label printer system.

11. The thermal label printer system of claim 1, wherein the input device comprises a matrix membrane keypad, a dome-switch keypad, a scissor-switch keypad, or a capacitive keypad.

12. The thermal label printer system of claim 1, wherein the input device comprises a wireless transceiver configured to receive an input signal from an external source.

13. The thermal label printer system of claim 1, wherein the display unit and the input device comprise a touchscreen.

14. The thermal label printer system of claim 1, wherein the cavity is defined by a first recess formed in the first interior surface of the front cover and a second recess formed in the second interior surface of the rear cover.

15. The thermal label printer system of claim 1, wherein the label comprises thermal paper with an adhesive backing.

16. The thermal label printer system of claim 1, further comprising a securing device configured to hold the book-shaped housing in the closed position, wherein the securing device comprises a belt, a latch, a magnet, snap buttons, or some combination thereof.

17. The thermal label printer system of claim 1, wherein the expiration date comprises a best-by date, a use-by date, or another suitable date.

18. A thermal label printer system, comprising:
a book-shaped housing comprising a front cover and a rear cover, the front cover attached to a rear cover along an interface and configured to rotate about the interface with respect to the rear cover between an open position and a closed position, wherein the front cover and the rear cover each comprise hard plastic, shock absorbing, waterproof material, wherein the front cover and the rear cover are sealed to each other at a sealing interface in the closed position to prevent liquids from entering into the book-shaped housing, and wherein a first interior surface of the front cover and a second interior surface of the rear cover define a cavity in the closed position;
a thermal printer comprising:
a printer casing secured to the second interior surface of the rear cover of the book-shaped housing;
an input device, wherein the input device comprises a matrix membrane keypad secured to an exterior of the printer casing;
a thermal print head; and
a controller configured to determine an output based on inputs received via the input device, the inputs comprising a food code corresponding to a food item, a second code corresponding to an in-kitchen storage location for the food item, a third code corresponding to a cooked or uncooked status of the food item, and a fourth code corresponding to a cook date of the food item, wherein the input corresponding to the in-kitchen storage location for the food item is selected from a group of options comprising a freezer, a refrigerator, and a pantry, wherein the output is configured to cause the thermal print head to print a thermal label within an adhesive backing, and wherein the thermal label comprises at least a name of a food item and a determined expiration date for the food item.

19. The thermal label printer system of claim 18, wherein the interface further comprises the hard plastic material and the shock absorbing material.

20. A method, comprising:
activating a thermal printer secured within a book-shaped housing comprising a front cover and a rear cover, the front cover attached to a rear cover along an interface and configured to rotate about the interface with respect to the rear cover between an open position and a closed position, and wherein a first interior surface of the front cover and a second interior surface of the rear cover define a cavity in the closed position;
receiving input from a user interface of the thermal printer, wherein the received input comprises a food code corresponding to a food item, a cooked or uncooked status of the food, a cook date of the food, and an in-kitchen storage location for the food, wherein an input corresponding to the in-kitchen storage location for the food item is selected from a group of options comprising a freezer, a refrigerator, and a pantry;
determining, via a controller of the thermal printer, a number of days until expiration of the food item based at least in part on the received input;
retrieving a current date from a real-time clock in electronic communication with the controller;
calculating an expiration date for the food item based on the received input indicating the cooked or uncooked status of the food item, the cook date of the food item, the in-kitchen storage location for the food item, and the current date; and
printing a thermal label comprising a name of the food item and the calculated expiration date for the food item.

21. (canceled)
